(19) United States
(12) Patent Application Publication
(10) Pub. No.: US 2021/0241307 A1
(43) Pub. Date: Aug. 5, 2021

(54) SYSTEM AND METHOD FOR DYNAMIC AUDIENCE MAPPING AND PROMOTION EXECUTION

(71) Applicant: salesforce.com, inc., San Francisco, CA (US)

(72) Inventors: Natalija Pavic, Whitby (CA); Daniel Thomas Harrison, Newmarket (CA)

(21) Appl. No.: 16/778,139

(22) Filed: Jan. 31, 2020

(51) Int. Cl. G06Q 30/02; G06N 20/00

(52) U.S. Cl. CPC G06Q 30/0224; G06N 20/00; G06Q 30/0201

(57) ABSTRACT

A method of targeting a promotion to an appropriate audience includes: performing clustering analysis on anonymized customer data using artificial intelligence to segment the anonymized data into a plurality of audience clusters; applying a matching algorithm to match a personalized promotion to a first audience cluster; sending the personalized promotion using a digital display channel to a plurality of individuals matching characteristics of the first audience cluster; receiving and recording results from the personalized promotion; and iteratively adjusting the personalized promotion based on the results from the personalized promotion. The iteratively adjusting includes: adjusting terms of the personalized promotion, sending the adjusted personalized promotion to a plurality of individuals, recording the success and failure of the adjusted personalized promotion, measuring the success of the adjusted personalized promotion, and repeating the adjusting, sending, recording, and measuring until a desired business result is obtained or a predetermined promotion adjustment ending point has been reached.

### TECHNICAL FIELD

Embodiments of the subject matter described herein relate generally computing systems, and more particularly to computing systems that have been adapted to automate audience creation (e.g., who should get a marketing message) and promotion execution.

### BACKGROUND

Companies/organizations engaged with using promotions face the challenge of driving sales while also maintaining profitability. Unfortunately, many decisions are largely made through “gut-feel”. A retailer might decide to run a promotion but not have a good way to understand whether the promotion will create a revenue lift without cannibalizing existing sales. In a common scenario, a retailer creates an online flash sale with a 10% off promotion. During the promotion, online sales increase by 20%, but when the retailer evaluates the sales, the retailer notices that revenue has dipped. Without the promotion, some customers would have made the purchase and paid full price, but instead, made the purchase online at a lower cost, thereby driving down overall profitability. Despite the revenue lift, the promotion lost money for the retailer.

Companies/organizations today have neither an automated way to understand which promotions are working nor an automated way to make decisions on which promotions should be run. Additionally, companies/organizations do not have tools to identify audiences to which promotions should be directed and which promotions to direct to which audience.

### SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a system for targeting an appropriate promotion to an appropriate audience is disclosed. The system includes a controller that is configured to: ingest anonymized data regarding a plurality of individuals who purchase goods and/or services in the marketplace, wherein the anonymized data includes demographic information and sales data, wherein the sales data includes data regarding purchases made in response to some form of advertising and/or promotion; perform clustering analysis on the ingested anonymized data using artificial intelligence to segment the anonymized data into a plurality of audience clusters wherein each audience cluster is partitioned as a coherent group that uses the same purchasing pattern; apply a matching algorithm to match a personalized promotion to a first audience cluster; send the personalized promotion using a digital display channel (e.g., social media, content management system, website) to a plurality of individuals matching characteristics of the first audience cluster; receive and record results from the personalized promotion with the plurality of individuals matching characteristics of the first audience cluster, wherein the results include data regarding the success and failure (e.g., conversion rate, did the promotion increase sales, did promotion cannibalize sales that would have taken place without the promotion, did promotion cause sales that would have taken place to take place earlier) of the personalized promotion; and iteratively adjust the personalized promotion based on the results from the personalized promotion. To iteratively adjust, the controller is configured to: adjust terms of the personalized promotion, send the adjusted personalized promotion using a digital display channel to a plurality of individuals matching characteristics of the first audience cluster, record the success and failure of the adjusted personalized promotion in driving a desired business result (e.g., margin, revenue, market share, etc.), measure the success of the adjusted personalized promotion, and repeat the adjusting, sending, recording, and measuring until the desired business result is obtained or a predetermined promotion adjustment ending point has been reached (e.g., predetermined number or maximum promotion level reached).

In another embodiment, a processor-implemented method of targeting an appropriate promotion to an appropriate audience is disclosed. The method includes: ingesting anonymized data regarding a plurality (e.g., thousands) of individuals who purchase goods and/or services in the marketplace, wherein the anonymized data includes demographic information and sales data, wherein the sales data includes data regarding purchases made in response to some form of advertising; performing clustering analysis on the ingested anonymized data using artificial intelligence to segment the anonymized data into a plurality of audience clusters wherein each audience cluster is partitioned as a coherent group that uses the same purchasing pattern; applying a matching algorithm to match a personalized promotion to a first audience cluster; sending the personalized promotion using a digital display channel (e.g., social media, content management system, website) to a plurality of individuals matching characteristics of the first audience cluster; receiving and recording results from the personalized promotion with the plurality of individuals matching characteristics of the first audience cluster, wherein the results include data regarding the success and failure (e.g., conversion rate, did the promotion increase sales, did promotion cannibalize sales that would have taken place without the promotion, did promotion cause sales that would have taken place to take place earlier) of the personalized promotion; and iteratively adjusting the personalized promotion based on the results from the personalized promotion. The iteratively adjusting includes: adjusting terms of the personalized promotion, sending the adjusted personalized promotion using a digital display channel to a plurality of individuals matching characteristics of the first audience cluster, recording the success and failure of the adjusted personalized promotion in driving a desired business result (e.g., margin, revenue, market share, etc.), measuring the success of the adjusted personalized promotion, and repeating the adjusting, sending, recording, and measuring until the desired business result is obtained or a predetermined promotion adjustment ending point has been reached (e.g., predetermined number or maximum promotion level reached).

Furthermore, other desirable features and characteristics will become apparent from the subsequent detailed description and the appended claims, taken in conjunction with the accompanying drawings and the preceding background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram depicting an example Dynamic Audience Mapping and Promotion Execution (DAMPE) system for targeting an appropriate promotion to an appropriate audience, in accordance with some embodiments.

FIG. 2 is a process flow chart depicting an example processor-implemented method of targeting an appropriate promotion to an appropriate audience, in accordance with some embodiments.

### DETAILED DESCRIPTION

The following disclosure provides many different embodiments, or examples, for implementing different features of the provided subject matter. The following detailed description is merely exemplary in nature and is not intended to limit the invention or the application and uses of the invention. Furthermore, there is no intention to be bound by any theory presented in the preceding background or the following detailed description.

The subject matter described herein discloses apparatus, systems, techniques and articles for targeting an appropriate promotion to an appropriate audience. The apparatus, systems, techniques and articles described herein may automatically suggest target audiences for sales promotions, automatically suggest promotions that should be utilized based on inherent profitability, and ultimately deliver specific promotions to specific audiences in an effort to achieve maximum sales lift optimized against profitability.

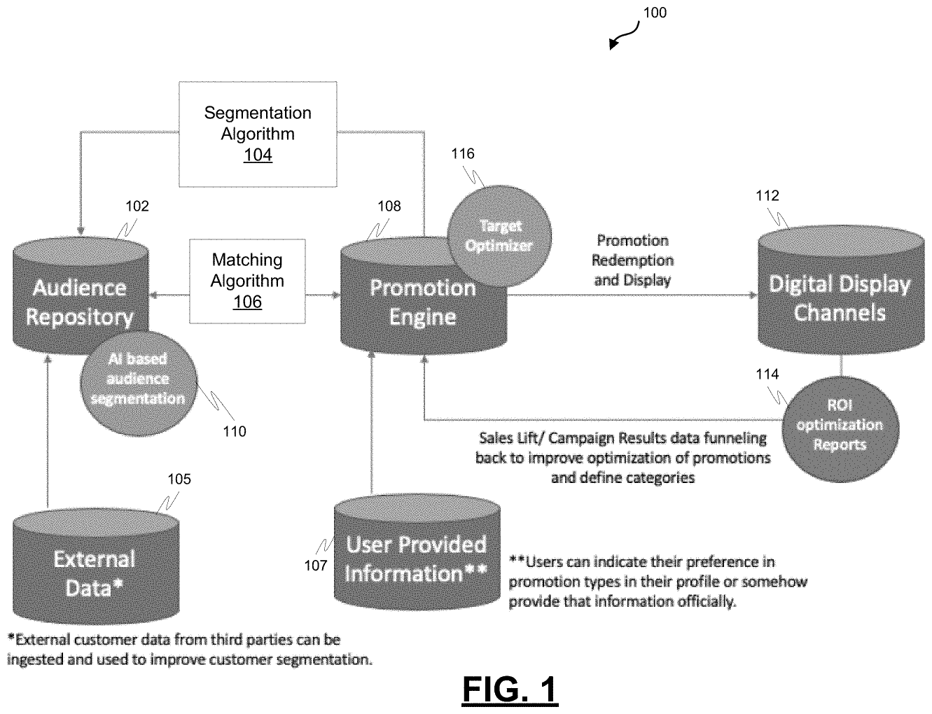

FIG. 1 is a block diagram depicting an example Dynamic Audience Mapping and Promotion Execution (DAMPE) system 100 for targeting an appropriate promotion to an appropriate audience. The DAMPE system 100 is configured, using artificial intelligence (AI), to automatically suggest target audiences for sales promotions, automatically suggest promotions that should be utilized, and deliver specific promotions to specific audiences. Additionally, the DAMPE system 100 is configured to obtain outcome information from delivering specific promotions to specific audiences and create an iterative feedback loop to strengthen the personalization and targeting of promotions to specific audiences.

The example system 100 uses AI to create segmented customer audiences. Audiences are segmented based on their susceptibility to different promotional categories since different audience groups have different buying preferences. As an example, one audience group may respond to discounts these people desire the lowest price; another audience group may respond to exclusive content these people desire special or early access to products such as fancy sneakers, clothing, electronics, etc.; another audience group may respond to earning more loyalty points or a status such as those who choose flights or hotels based on earning points or those with an emotional loyalty to a company (e.g., always buy Ford); and another audience group may respond to ethical or environmental messaging a growing segment of people exist who want to make purchases that align with their personal beliefs. The example DAMPE system 100 is configured to create intelligent audience segments based on data. This can be challenging because a potential customer may be in a different audience group depending on the product type, extent of the offer, and a potential customer's preferences may change over time.

The example DAMPE system 100 uses AI and margin information to design promotions as compared to current practices where, when creating promotions, a retailer may calculate by hand the cost of the promotion to the business. The example DAMPE system 100 can create promotions with a basket that include loss leading items that are bundled with other items wherein the purchase of the entire basket is profitable. The example DAMPE system 100 is configured to create basket profit/loss (P/L) simulations based on various promotions. The example DAMPE system 100 aims to create the best promotions for each audience group. The example DAMPE system 100 is configured to accomplish this through a market basket analysis executed by AI.

The DAMPE system 100 uses a dynamic allocation engine (comprising a matching algorithm 106) that will assign relevant promotions to relevant audiences. The DAMPE system 100 is configured to consider data regarding the success and failure of promotions and iterate to improve the ability of the dynamic allocation engine to match specific audience groups with the right promotion.

The example DAMPE system 100 includes an audience repository 102, a segmentation algorithm 104, a matching algorithm 106, and a promotion engine 108 and is implemented using a controller comprising at least one processor and a computer-readable storage device or media encoded with programming instructions for configuring the controller. The processor may be any custom-made or commercially available processor, a central processing unit (CPU), a graphics processing unit (GPU), an application specific integrated circuit (ASIC), a field programmable gate array (FPGA), an auxiliary processor among several processors associated with the controller, a semiconductor-based microprocessor (in the form of a microchip or chip set), any combination thereof, or generally any device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable programming instructions, used by the controller. The audience repository 102 is implemented using a computer readable storage device or media and is configured to store audience data.

The example segmentation algorithm 104 applies AI, is executed by the controller, and is configured to cause anonymized audience data to be stored in the audience repository 102 along with any pre-existing customer data. The segmentation algorithm 104 is configured to ingest information regarding customer responses to promotions from multiple sources including resulting sales lift data, third party data sources 105, and any data that can be used to enrich the algorithm (including user provided data 107). The segmentation algorithm 104 is configured to ingest anonymized data regarding thousands of individuals who purchase goods and/or services in the marketplace, wherein the anonymized data may include demographic information and sales data, and wherein the sales data may include data regarding purchases made in response to some form of advertising and/or promotion and data regarding an increase in sales due to the advertising and/or promotion. The anonymized data may come from one company's data set or the anonymized data may come from the data sets of a plurality of unrelated companies. The segmentation algorithm 104 may also be configured to directly incorporate user provided information 107 which can be provided in the clear or via blockchain encoded data. When incorporating user provided information, the segmentation algorithm 104 is configured to incorporate the information in a way that allows the identity of the user to be unknown. This can allow audience groups to include user provided information, and the user provided information to influence promotion selection without the identity of the user being shared.

The segmentation algorithm 104 is further configured to create audience groups 110 from the audience data. The segmentation algorithm 104 is configured to perform clustering analysis on the ingested anonymized data or an existing database of customer data using AI to segment the anonymized data into a plurality of audience clusters or groups 110 wherein each audience cluster is partitioned as a coherent group that uses the same purchasing pattern. Further, the segmentation algorithm 104 may be refined, over time, using machine learning techniques, based on sales results reported from past promotions to better identify the type of audience cluster to define for a particular type of promotion.

The matching algorithm 106 is executed by the controller and is configured to closely correlate specific audience groups to specific promotions to identify which promotion is applicable to which audience group. In particular, the matching algorithm 106 is configured to match a personalized promotion generated by the promotion engine 108 to an audience cluster identified by the segmentation algorithm 104 and is further configured to match one or more additional personalized promotions generated by the promotion engine 108 to one or more different audience clusters identified by the segmentation algorithm 104. The matching algorithm 106 may be refined using machine learning techniques, based on sales results reported from past promotions aimed at a particular audience group, in an iterative manner, to determine the type of promotion that works best with a particular audience cluster.

The matching algorithm 106 may be further configured to determine a SPP (susceptibility to purchase with a promotion) and degree of SPP for each of a plurality of audience clusters for a plurality of promotions based on sales results reported from past promotions. The matching algorithm 106 may then use the SPP and degree of SPP of an audience cluster to match the audience cluster to a particular promotion. The matching algorithm 106 may also use the SPP and degree of SPP of an audience cluster to identify the audience cluster that is the best match to a particular promotion.

The matching algorithm 106 may be refined using machine learning techniques based on A/B testing, wherein the A/B testing includes: sending a particular advertisement having a particular promotion to a group of individuals matching a particular audience cluster and sending a different advertisement without the particular promotion to a control group, measuring the results (e.g., conversion rate and/or profitability) for each advertisement, and determining the success of the promotion based on the comparison of difference in results from each advertisement. The matching algorithm 106 may also be adapted to identify an audience cluster that was defined for one product or service that may be matched to a personalized promotion for a different product or service.

The promotion engine 108 is implemented by the controller and is configured to generate one or more personalized promotions and cause a personalized promotion identified by the matching algorithm 106 to be sent using a digital display channel 112 (e.g., social media, content management system, website) to a plurality of individuals matching characteristics of an audience cluster identified by the matching algorithm 106. The promotion engine 108 is further configured to receive and record results from a personalized promotion it caused to be sent. The results may be received from a ROI (return on investment) engine implemented by a controller that collect sales results. The results may be included in a optimization report 114. The results may include data regarding the success and failure (e.g., conversion rate, did the promotion increase sales, did promotion cannibalize sales that would have taken place without the promotion, did promotion cause sales that would have taken place to take place earlier, etc.) of a personalized promotion.

The promotion engine 108 is further configured to iteratively adjust the personalized promotion (e.g., by a target optimizer 116) based on the results from the personalized promotion. To iteratively adjust the promotion, the promotion engine 108 may: adjust terms of the personalized promotion (e.g., percentage off price), cause the adjusted personalized promotion to be sent using a digital display channel 112 to a plurality of individuals matching characteristics of a targeted audience cluster, record the success and failure of the adjusted personalized promotion in driving a desired business result (e.g., margin, revenue, market share, etc.), measure the success of the adjusted personalized promotion, and repeat the adjusting, sending, recording, and measuring until the desired business result is obtained or a predetermined promotion adjustment ending point has been reached. A predetermined adjustment ending point, for example, could be a predetermined number of promotion adjustments, a maximum promotion term reached (e.g., maximum percentage off price), and others.

The information regarding the success and failure of the adjusted personalized promotion may be recorded in a blockchain data structure for future use by a DAMPE system adapted for use by a different entity. Additionally, use of the blockchain allows distinct organization to share information to be used with the DAMPE system such as to allow A/B testing to be executed with multiple parties controlled by smart contracts. In that regard, a DAMPE system may be configured to: retrieve, from a blockchain data structure, success and failure data used to train a first matching algorithm, used by a first entity, to match a first personalized promotion to a first audience cluster; and train a second matching algorithm, used by a second entity using the retrieved success and failure data, to match a second personalized promotion to a second audience cluster; apply the second matching algorithm to match the second personalized promotion to the second audience cluster; and send the second personalized promotion using a digital display channel to a group of individuals matching characteristics of the second audience cluster.

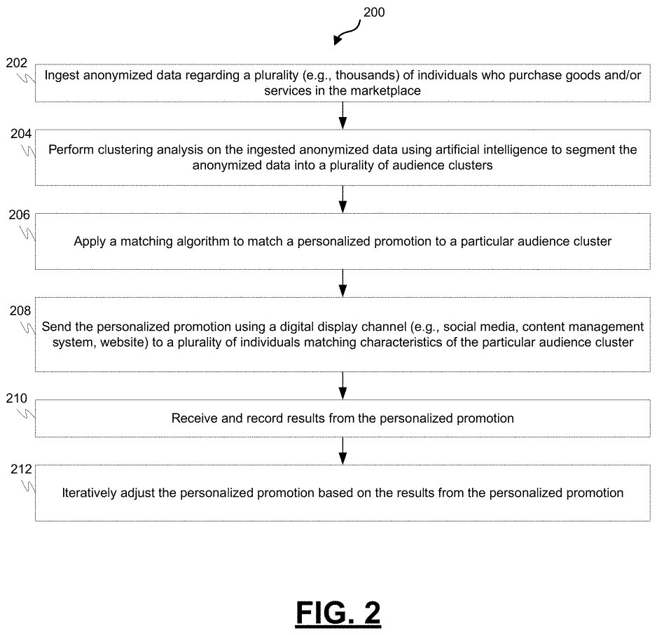

FIG. 2 is a process flow chart depicting an example processor-implemented method of targeting an appropriate promotion to an appropriate audience. The order of operation within the example process 200 is not limited to the sequential execution as illustrated in the figure, but may be performed in one or more varying orders as applicable and in accordance with the present disclosure.

The example process 200 includes ingesting anonymized data regarding a plurality (e.g., thousands) of individuals who purchase goods and/or services in the marketplace (operation 202). The anonymized data may include demographic information and sales data. The sales data may include data regarding purchases made in response to some form of advertising and/or promotion and data regarding an increase or decrease in sales due to the advertising and/or promotion. The anonymized data may come from one company's data set or the anonymized data may come from the data sets of a plurality of unrelated companies.

The example process 200 includes performing clustering analysis on the ingested anonymized data using artificial intelligence to segment the anonymized data into a plurality of audience clusters (operation 204). Each audience cluster is partitioned as a coherent group that uses the same purchasing pattern.

The example process 200 includes applying a matching algorithm to match a personalized promotion to a particular audience cluster (operation 206) and sending the personalized promotion using a digital display channel (e.g., social media, content management system, website) to a plurality of individuals matching characteristics of the particular audience cluster (operation 208). The applying and sending may include applying the matching algorithm to match a second personalized promotion to a second audience cluster; and sending the second personalized promotion using a digital display channel to a plurality of individuals matching characteristics of the second audience cluster.

The example process 200 includes receiving and recording results from the personalized promotion (operation 210). The results may include data regarding the success and failure (e.g., conversion rate, did the promotion increase sales, did promotion cannibalize sales that would have taken place without the promotion, did promotion cause sales that would have taken place to take place earlier) of the personalized promotion. The receiving and recording may include receiving results from the second personalized promotion with the plurality of individuals matching characteristics of the second audience cluster; and iteratively adjusting the second personalized promotion based on the results from the second personalized promotion.

The example process 200 includes iteratively adjusting the personalized promotion based on the results from the personalized promotion (operation 212). The iteratively adjusting may include: adjusting terms of the personalized promotion, sending the adjusted personalized promotion using a digital display channel to a plurality of individuals matching characteristics of the first audience cluster, recording the success and failure of the adjusted personalized promotion in driving a desired business result (e.g., margin, revenue, market share, etc.), measuring the success of the adjusted personalized promotion, and repeating the adjusting, sending, recording, and measuring until the desired business result is obtained or a predetermined promotion adjustment ending point has been reached (e.g., predetermined number or maximum promotion level reached).

The iteratively adjusting may allow for refining the matching algorithm using machine learning techniques based on iteratively adjusting a plurality of promotions to determine the type of promotion that works better with a particular audience cluster. The iteratively adjusting may allow for refining a clustering algorithm using machine learning techniques based on iteratively adjusting a plurality of promotions to determine the type of audience cluster to define for a particular type of promotion. A refined matching algorithm that has been refined by the iteratively adjusting may be configured by the refining to identify the type of audience cluster to match to a particular personalized promotion.

The iteratively adjusting may allow for determining a SPP (susceptibility to purchase with a promotion) and degree of SPP for a plurality of audience clusters for a plurality of promotions. The SPP and degree of SPP may be used by the matching algorithm to determine a particular audience cluster that may be matched to a particular personalized promotion.

The iteratively adjusting may include refining the matching algorithm using machine learning techniques based on A/B testing. A/B testing may include: sending a particular advertisement having a particular promotion to a group of individuals matching a particular audience cluster and sending a different advertisement without the particular promotion to a control group, measuring the results (e.g., conversion rate and/or profitability) for each advertisement, and determining the success of the promotion based on the comparison of difference in results from each advertisement.

The recording the success and failure of the adjusted personalized promotion may include recording the success and failure data in a blockchain data structure. The success and failure data used to train one matching algorithm to match a first personalized promotion to a first audience cluster may be retrieved from a blockchain data structure and used to train a second matching algorithm to match a second personalized promotion to a second audience cluster.

The subject matter described herein discloses apparatus, systems, techniques and articles for targeting an appropriate promotion to an appropriate audience. The apparatus, systems, techniques and articles described herein may automatically suggest target audiences for sales promotions, automatically suggest promotions that should be utilized based on inherent profitability, and ultimately deliver specific promotions to specific audiences in an effort to achieve maximum sales lift optimized against profitability. In one embodiment, a method of targeting a promotion to an appropriate audience includes: performing clustering analysis on anonymized customer data using artificial intelligence to segment the anonymized data into a plurality of audience clusters for optimized evaluation of the full populations such that the results can be applied across the entire population with a high degree of correlation; applying a matching algorithm to match a personalized promotion to a first audience cluster; sending the personalized promotion using a digital display channel to a plurality of individuals matching characteristics of the first audience cluster; receiving and recording results from the personalized promotion; and iteratively adjusting the personalized promotion based on the results from the personalized promotion. The iteratively adjusting includes: adjusting terms of the personalized promotion, sending the adjusted personalized promotion to a plurality of individuals, recording the success and failure of the adjusted personalized promotion, measuring the success of the adjusted personalized promotion, and repeating the adjusting, sending, recording, and measuring until a desired business result is obtained or a predetermined promotion adjustment ending point has been reached.

In another embodiment, a processor-implemented method of targeting an appropriate promotion to an appropriate audience is provided. The method comprises: ingesting anonymized data regarding a plurality (e.g., thousands) of individuals who purchase goods and/or services in the marketplace, wherein the anonymized data includes demographic information and sales data, wherein the sales data includes data regarding purchases made in response to some form of advertising and/or promotion; performing clustering analysis on the ingested anonymized data using artificial intelligence to segment the anonymized data into a plurality of audience clusters wherein each audience cluster is partitioned as a coherent group that uses the same purchasing pattern; applying a matching algorithm to match a personalized promotion to a first audience cluster; sending the personalized promotion using a digital display channel (e.g., social media, content management system, website) to a plurality of individuals matching characteristics of the first audience cluster; receiving and recording results from the personalized promotion with the plurality of individuals matching characteristics of the first audience cluster, wherein the results include data regarding the success and failure (e.g., conversion rate, did the promotion increase sales, did promotion cannibalize sales that would have taken place without the promotion, did promotion cause sales that would have taken place to take place earlier) of the personalized promotion with the plurality of individuals matching characteristics of the first audience cluster; and iteratively adjusting the personalized promotion based on the results from the personalized promotion. The iteratively adjusting comprises: adjusting terms of the personalized promotion, sending the adjusted personalized promotion using a digital display channel to a plurality of individuals matching characteristics of the first audience cluster, recording the success and failure of the adjusted personalized promotion in driving a desired business result (e.g., margin, revenue, market share, etc.), measuring the success of the adjusted personalized promotion, and repeating the adjusting, sending, recording, and measuring until the desired business result is obtained or a predetermined promotion adjustment ending point has been reached (e.g., predetermined number or maximum promotion level reached).

These aspects and other embodiments may include one or more of the following features. The method may further comprise: applying the matching algorithm to match a second personalized promotion to a second audience cluster; sending the second personalized promotion using a digital display channel to a plurality of individuals matching characteristics of the second audience cluster; receiving results from the second personalized promotion with the plurality of individuals matching characteristics of the second audience cluster; and iteratively adjusting the second personalized promotion based on the results from the second personalized promotion. The method may further comprise refining the matching algorithm using machine learning techniques based on iteratively adjusting a plurality of promotions to determine the type of promotion that works better with a particular audience cluster. The method may further comprise refining a segmentation algorithm using machine learning techniques based on iteratively adjusting a plurality of promotions to determine the type of audience cluster to define for a particular type of promotion. The method may further comprise applying the matching algorithm to determine a third audience cluster that is to be matched to a third personalized promotion. The method may further comprise determining a SPP (e.g., susceptibility to purchase with a promotion) and degree of SPP for a plurality of audience clusters for a plurality of promotions during the iteratively adjusting the first personalized promotion and the iteratively adjusting the second personalized promotion. The applying the matching algorithm to determine a third audience cluster that is to be matched to a third personalized promotion may comprise determining the third audience cluster that is to be matched to a third personalized promotion using the SPP and degree of SPP for the third audience cluster. The method may further comprise: refining the matching algorithm using machine learning techniques based on A/B testing, wherein the A/B testing includes: sending a first advertisement having a fourth promotion to a group of individuals matching a fourth audience cluster and sending a second advertisement without the fourth promotion to a control group, measuring the results (e.g., conversion rate and/or profitability) from the first advertisement and the second advertisement, and determining the success of the fourth promotion based on the comparison of results from the first advertisement and the second advertisement. The recording the success and failure of the adjusted personalized promotion may comprise recording the success and failure data in a blockchain data structure. The method may further comprise: retrieving, from a blockchain data structure, success and failure data used to train a first matching algorithm, used by a first entity, to match a first personalized promotion to a first audience cluster; training a second matching algorithm, used by a second entity using the retrieved success and failure data, to match a second personalized promotion to a second audience cluster; applying the second matching algorithm to match the second personalized promotion to the second audience cluster; and sending the second personalized promotion using a digital display channel to a group of individuals matching characteristics of the second audience cluster.

In another embodiment, a system for targeting an appropriate promotion to an appropriate audience is provided. The system comprises a controller configured to: ingest anonymized data regarding a plurality (e.g., thousands) of individuals who purchase goods and/or services in the marketplace, wherein the anonymized data includes demographic information and sales data, wherein the sales data includes data regarding purchases made in response to some form of advertising and/or promotion; perform clustering analysis on the ingested anonymized data using artificial intelligence to segment the anonymized data into a plurality of audience clusters wherein each audience cluster is partitioned as a coherent group that uses the same purchasing pattern; apply a matching algorithm to match a personalized promotion to a first audience cluster; send the personalized promotion using a digital display channel (e.g., social media, content management system, website) to a plurality of individuals matching characteristics of the first audience cluster; receive and record results from the personalized promotion with the plurality of individuals matching characteristics of the first audience cluster, wherein the results include data regarding the success and failure (e.g., conversion rate, did the promotion increase sales, did promotion cannibalize sales that would have taken place without the promotion, did promotion cause sales that would have taken place to take place earlier) of the personalized promotion with the plurality of individuals matching characteristics of the first audience cluster; and iteratively adjust the personalized promotion based on the results from the personalized promotion. To iteratively adjust, the controller is configured to: adjust terms of the personalized promotion, send the adjusted personalized promotion using a digital display channel to a plurality of individuals matching characteristics of the first audience cluster, record the success and failure of the adjusted personalized promotion in driving a desired business result (e.g., margin, revenue, market share, etc.), measure the success of the adjusted personalized promotion, and repeat the adjusting, sending, recording, and measuring until the desired business result is obtained or a predetermined promotion adjustment ending point has been reached (e.g., predetermined number or maximum promotion level reached).

These aspects and other embodiments may include one or more of the following features. The controller may be further configured to: apply the matching algorithm to match a second personalized promotion to a second audience cluster; send the second personalized promotion using a digital display channel to a plurality of individuals matching characteristics of the second audience cluster; receive results from the second personalized promotion with the plurality of individuals matching characteristics of the second audience cluster; and iteratively adjust the second personalized promotion based on the results from the second personalized promotion. The controller may be further configured to refine the matching algorithm using machine learning techniques based on iteratively adjusting a plurality of promotions to determine the type of promotion that works better with a particular audience cluster. The controller may be further configured to refine a segmentation algorithm using machine learning techniques based on iteratively adjusting a plurality of promotions to determine the type of audience cluster to define for a particular type of promotion. The controller may be further configured to apply the matching algorithm to determine a third audience cluster that may be to be matched to a third personalized promotion. The controller may be further configured to determine a SPP (e.g., susceptibility to purchase with a promotion) and degree of SPP for a plurality of audience clusters for a plurality of promotions during the iteratively adjusting the first personalized promotion and the iteratively adjusting the second personalized promotion. To apply the matching algorithm to determine a third audience cluster that may be to be matched to a third personalized promotion, the controller may be configured to determine the third audience cluster that may be to be matched to a third personalized promotion using the SPP and degree of SPP for the third audience cluster. The controller may be further configured to: refine the matching algorithm using machine learning techniques based on A/B testing, wherein the A/B testing includes: sending a first advertisement having a fourth promotion to a group of individuals matching a fourth audience cluster and sending a second advertisement without the fourth promotion to a control group, measuring the results (e.g., conversion rate and/or profitability) from the first advertisement and the second advertisement, and determining the success of the fourth promotion based on the comparison of results from the first advertisement and the second advertisement. To record the success and failure of the adjusted personalized promotion the controller may be configured to record the success and failure data in a blockchain data structure. The controller may be further configured to: retrieve, from a blockchain data structure, success and failure data used to train a first matching algorithm, used by a first entity, to match a first personalized promotion to a first audience cluster; train a second matching algorithm, used by a second entity using the retrieved success and failure data, to match a second personalized promotion to a second audience cluster; apply the second matching algorithm to match the second personalized promotion to the second audience cluster; and send the second personalized promotion using a digital display channel to a group of individuals matching characteristics of the second audience cluster.

In another embodiment, non-transitory computer readable media encoded with programming instructions configurable to cause a controller to perform a method is provided. The method comprises: ingesting anonymized data regarding a plurality (e.g., thousands) of individuals who purchase goods and/or services in the marketplace, wherein the anonymized data includes demographic information and sales data, wherein the sales data includes data regarding purchases made in response to some form of advertising and/or promotion; performing clustering analysis on the ingested anonymized data using artificial intelligence to segment the anonymized data into a plurality of audience clusters wherein each audience cluster is partitioned as a coherent group that uses the same purchasing pattern; applying a matching algorithm to match a personalized promotion to a first audience cluster; sending the personalized promotion using a digital display channel (e.g., social media, content management system, website) to a plurality of individuals matching characteristics of the first audience cluster; receiving and recording results from the personalized promotion with the plurality of individuals matching characteristics of the first audience cluster, wherein the results include data regarding the success and failure (e.g., conversion rate, did the promotion increase sales, did promotion cannibalize sales that would have taken place without the promotion, did promotion cause sales that would have taken place to take place earlier) of the personalized promotion with the plurality of individuals matching characteristics of the first audience cluster; and iteratively adjusting the personalized promotion based on the results from the personalized promotion. The iteratively adjusting comprises: adjusting terms of the personalized promotion, sending the adjusted personalized promotion using a digital display channel to a plurality of individuals matching characteristics of the first audience cluster, recording the success and failure of the adjusted personalized promotion in driving a desired business result (e.g., margin, revenue, market share, etc.), measuring the success of the adjusted personalized promotion, and repeating the adjusting, sending, recording, and measuring until the desired business result is obtained or a predetermined promotion adjustment ending point has been reached (e.g., predetermined number or maximum promotion level reached).

These aspects and other embodiments may include one or more of the following features. The method may further comprise: applying the matching algorithm to match a second personalized promotion to a second audience cluster; sending the second personalized promotion using a digital display channel to a plurality of individuals matching characteristics of the second audience cluster; receiving results from the second personalized promotion with the plurality of individuals matching characteristics of the second audience cluster; and iteratively adjusting the second personalized promotion based on the results from the second personalized promotion. The method may further comprise refining the matching algorithm using machine learning techniques based on iteratively adjusting a plurality of promotions to determine the type of promotion that works better with a particular audience cluster. The method may further comprise refining a segmentation algorithm using machine learning techniques based on iteratively adjusting a plurality of promotions to determine the type of audience cluster to define for a particular type of promotion. The method may further comprise applying the matching algorithm to determine a third audience cluster that is to be matched to a third personalized promotion. The method may further comprise determining a SPP (e.g., susceptibility to purchase with a promotion) and degree of SPP for a plurality of audience clusters for a plurality of promotions during the iteratively adjusting the first personalized promotion and the iteratively adjusting the second personalized promotion. The applying the matching algorithm to determine a third audience cluster that is to be matched to a third personalized promotion may comprise determining the third audience cluster that is to be matched to a third personalized promotion using the SPP and degree of SPP for the third audience cluster. The method may further comprise: refining the matching algorithm using machine learning techniques based on A/B testing, wherein the A/B testing includes: sending a first advertisement having a fourth promotion to a group of individuals matching a fourth audience cluster and sending a second advertisement without the fourth promotion to a control group, measuring the results (e.g., conversion rate and/or profitability) from the first advertisement and the second advertisement, and determining the success of the fourth promotion based on the comparison of results from the first advertisement and the second advertisement. The recording the success and failure of the adjusted personalized promotion may comprise recording the success and failure data in a blockchain data structure. The method may further comprise: retrieving, from a blockchain data structure, success and failure data used to train a first matching algorithm, used by a first entity, to match a first personalized promotion to a first audience cluster; training a second matching algorithm, used by a second entity using the retrieved success and failure data, to match a second personalized promotion to a second audience cluster; applying the second matching algorithm to match the second personalized promotion to the second audience cluster; and sending the second personalized promotion using a digital display channel to a group of individuals matching characteristics of the second audience cluster.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” or “example” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to object models, web pages, cloud computing, on-demand applications, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first,” “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

While at least one exemplary embodiment has been presented, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

1. A system for executing an advertising campaign that iteratively adjusts a promotion displayed to targets viewers, the system comprising:
a controller comprising at least one processor and a computer-readable storage device encoded with programming instructions for configuring the at least one processor, the controller having access to anonymized data regarding a plurality of individuals who purchase goods and/or services in the marketplace, the anonymized data including demographic information and sales data, the sales data including data regarding purchases made in response to some form of advertising and/or promotion, wherein the controller causes the system to:
generate a plurality of audience clusters from the anonymized data using a segmentation algorithm that is refined over time using machine learning techniques based on sales results reported from past promotions to identify a type of audience cluster to define for a particular type of promotion wherein each audience cluster is partitioned as a coherent group based on buying preferences;
generate a first result including a personalized promotion and a first audience cluster from the plurality of audience clusters using a matching algorithm that is refined using machine learning techniques based on sales results reported from past promotions aimed at a particular audience group to identify a type of promotion to apply to the first audience cluster;
signal using a digital display channel to a plurality of user interfaces for a plurality of individuals matching characteristics of the first audience cluster to display the personalized promotion;
generate a second result including a first measurement of success of the personalized promotion with the plurality of individuals matching characteristics of the first audience cluster, the first measurement of success including one or more of margin, revenue, or market share; and
repeat adjusting one or more terms of the personalized promotion based on the first measurement of success of the personalized promotion signaling to a plurality of user interfaces for another plurality of individuals matching characteristics of the first audience cluster to display the personalized promotion, and generating the second result until the earliest of the first measurement of success reaching a desired measurement of success or a predetermined promotion adjustment ending point being reached.

2. The system of claim 1, wherein the controller is further configured to:
generate a third result including a second personalized promotion and a second audience cluster from the plurality of audience clusters using the matching algorithm;
signal using a digital display channel to a plurality of individuals matching characteristics of the second audience cluster to display the second personalized promotion;
generate a fourth result including a second measurement of success of the personalized promotion with the plurality of individuals matching characteristics of the second audience cluster, the second measurement of success including one or more of margin, revenue, or market share; and
repeat adjusting one or more terms of the second personalized promotion based on the second measurement of success of the second personalized promotion, signaling to a plurality of user interfaces for another plurality of individuals to display the personalized promotion, and generating the fourth result until the earliest of the second measurement of success reaching a second desired measurement of success or a second predetermined promotion adjustment ending point being reached.

3. The system of claim 1, wherein the buying preferences include one or more of: preference for the lowest price; preference for special or early access to products; preference for earning loyalty points or a status; or preference for ethical or environmental messaging.

4. (canceled)

5. (canceled)

6. The system of claim 1, wherein the controller is further configured to determine a SPP (susceptibility to purchase with a promotion) and degree of SPP for a plurality of audience clusters for a plurality of promotions when repeated adjusting one or more terms of the personalized promotion based on the first measurement of success of the personalized promotion, signaling to a plurality of user interfaces for another plurality of individuals matching characteristics of the first audience cluster to display the personalized promotion, and generating the second result until the earliest of the first measurement of success reaching a desired measurement of success or a predetermined promotion adjustment ending point being reached.

7. The method of claim 6, wherein the matching algorithm is configured to match a personalized promotion to a particular promotion using the SPP and degree of SPP.

8. The system of claim 1, wherein the controller is configured to:
refine the matching algorithm using machine learning techniques based on A/B testing, the A/B testing including: sending a first advertisement having a first promotion to a group of individuals matching a third audience cluster and sending a second advertisement without the first promotion to a control group, measuring results from the first advertisement and the second advertisement, and determining the success of the first promotion based on the comparison of results from the first advertisement and the second advertisement.

9. The system of claim 1, wherein the controller is further configured to record sales results from each iteration of the adjusting one or more terms of the personalized promotion based on the first measurement of success of the personalized promotion and the signaling to a plurality of user interfaces for another plurality of individuals matching characteristics of the first audience cluster to display the personalized promotion in a blockchain data structure.

10. The system of claim 1, wherein the controller is further configured to retrieve, from a blockchain data structure, sales results reported from past promotions to:
train the segmentation algorithm using machine learning techniques to identify the type of audience cluster to define for a particular type of promotion; and
train the matching algorithm using machine learning techniques to identify the type of promotion to apply to a particular audience cluster.

11. A method for executing an advertising campaign that iteratively adjusts a promotion displayed to targets viewers the method comprising:
generating a plurality of audience clusters from anonymized data regarding a plurality of individuals who purchase goods and/or services in the marketplace, the anonymized data including demographic information and sales data, the sales data including data regarding purchases made in response to some form of advertising and/or promotion, wherein each audience cluster is partitioned as a coherent group based on buying preferences;
generating a first result including a personalized promotion to and a first audience cluster from the plurality of audience clusters using a matching algorithm that is refined using machine learning techniques based on sales results reported from past promotions aimed at a particular audience group to identify a type of promotion to apply to the first audience cluster;
signaling using a digital display channel to a plurality of user interfaces for a plurality of individuals matching characteristics of the first audience cluster to display the personalized promotion;
generating a second result including a first measurement of success of the personalized promotion with the plurality of individuals matching characteristics of the first audience cluster, the first measurement of success including one or more of margin, revenue, or market share; and
repeating adjusting one or more terms of the personalized promotion based on the first measurement of the personalized promotion, signaling to a plurality of user interfaces for another plurality of individuals matching characteristics of the first audience cluster to display the personalized promotion, and generating the second result until the earliest of the first measurement of success reaching a desired measurement of success or a predetermined promotion adjustment ending point being reached.

12. The method of claim 11, further comprising:
generating a third result including a second personalized promotion and a second audience cluster from the plurality of audience clusters using the matching algorithm;
signaling using a digital display channel to a plurality of individuals matching characteristics of the second audience cluster to display the second personalized promotion;
generating a fourth result including a second measurement of success of the personalized promotion with the plurality of individuals matching characteristics of the second audience cluster, the second measurement of success including one or more of margin, revenue, or market share; and
repeating adjusting one or more terms of the second personalized promotion based on the second measurement of success of the second personalized promotion, signaling to a plurality of user interfaces for another plurality of individuals to display the personalized promotion, and generating the fourth result until the earliest of the second measurement of success reaching a second desired measurement of success or a second predetermined promotion adjustment ending point being reached.

13. The method of claim 11, wherein the buying preferences include one or more of: preference for the lowest price; preference for special or early access to products; preference for earning loyalty points or a status; or preference for ethical or environmental messaging.

14. (canceled)

15. (canceled)

16. The method of claim 11, further comprising to determine a SPP and degree of SPP (susceptibility to purchase with a promotion) for a plurality of audience clusters for a plurality of promotions when repeating adjusting one or more terms of the personalized promotion based on the first measurement of success of the personalized promotion, signaling to a plurality of user interfaces for another plurality of individuals matching characteristics of the first audience cluster to display the personalized promotion, and generating the second result until the earliest of the first measurement of success reaching a desired measurement of success or a predetermined promotion adjustment ending point being reached.

17. The method of claim 16, wherein the matching algorithm is configured to match to a personalized promotion to a particular promotion using the SPP and degree of SPP.

18. The method of claim 11, further comprising:
refining the matching algorithm using machine learning techniques based on A/B testing, the A/B testing including: sending a first advertisement having a first promotion to a group of individuals matching a third audience cluster and sending a second advertisement without the first promotion to a control group, measuring the results from the first advertisement and the second advertisement, and determining the success of the first promotion based on the comparison of results from the first advertisement and the second advertisement.

19. The method of claim 11, further comprising recording sales results from each iteration of the adjusting one or more terms of the personalized promotion based on the first measurement of success of the personalized promotion and the signaling to a plurality of user interfaces for another plurality of individuals matching characteristics of the first audience cluster to display the personalized promotion in a blockchain data structure.

20. Non-transitory computer readable media encoded with programming instructions configurable to cause a controller to perform a method for executing an advertising campaign that iteratively adjusts a promotion displayed to targets viewers, the method comprising:
generating a plurality of audience clusters from anonymized data regarding a plurality of individuals who purchase goods and/or services in the marketplace, the anonymized data including demographic information and sales data, the sales data including data regarding purchases made in response to some form of advertising and/or promotion, wherein each audience cluster is partitioned as a coherent group based on buying preferences;
generating a first result including a personalized promotion and a first audience cluster from the plurality of audience clusters using a matching algorithm that is refined using machine learning techniques based on sales results reported from past promotions aimed at a particular audience group to identify a type of promotion to apply to the first audience cluster;
signaling using a digital display channel to a plurality of user interfaces for a plurality of individuals matching characteristics of the first audience cluster to display the personalized promotion;
generating a second result including a first measurement of success of the personalized promotion with the plurality of individuals matching characteristics of the first audience cluster, the first measurement of success including one or more of margin, revenue, or market share; and
repeating adjusting, one or more terms of the personalized promotion based on the first measurement of success of the personalized promotion, signaling to a plurality of user interfaces for another plurality of individuals matching characteristics of the first audience cluster to display the personalized promotion, and generating the second result until the earliest of the first measurement of success reaching a desired measurement of success or a predetermined promotion adjustment ending point being reached.

21. The non-transitory computer readable media of claim 20, wherein the method further comprises:
generating a third result including a second personalized promotion and a second audience cluster from the plurality of audience clusters using the matching algorithm;
signaling using a digital display channel to a plurality of individuals matching characteristics of the second audience cluster to display the second personalized promotion;
generating a fourth result including a second measurement of success of the personalized promotion with the plurality of individuals matching characteristics of the second audience cluster, the second measurement of success including one or more of margin, revenue, or market share; and
repeating adjusting one or more terms of the second personalized promotion based on the second measurement of success of the second personalized promotion, signaling to a plurality of user interfaces for another plurality of individuals to display the personalized promotion, and generating the fourth result until the earliest of the second measurement of success reaching a second desired measurement of success or a second predetermined promotion adjustment ending point being reached.

22. The non-transitory computer readable media of claim 20, wherein the buying preferences include one or more of: preference for the lowest price; preference for special or early access to products; preference for earning loyalty points or a status; or preference for ethical or environmental messaging.

23. The non-transitory computer readable media of claim 20, wherein the method further comprises retrieving, from a blockchain data structure, sales results reported from past promotions to:
train the segmentation algorithm using machine learning techniques to identify the type of audience cluster to define for a particular type of promotion; and
train the matching algorithm using machine learning techniques to identify the type of promotion to apply to a particular audience cluster.

24. The method of claim 19, further comprising retrieving, from a blockchain data structure, sales results reported from past promotions to:
train the segmentation algorithm using machine learning techniques to identify the type of audience cluster to define for a particular type of promotion; and
train the matching algorithm using machine learning techniques to identify the type of promotion to apply to a particular audience cluster.
